(19) United States
(12) Patent Application Publication
(10) Pub. No.: US 2018/0341455 A1
(43) Pub. Date: Nov. 29, 2018

(54) Method and Device for Processing Audio in a Captured Scene Including an Image and Spatially Localizable Audio

(71) Applicant: Motorola Mobility LLC, Chicago, IL (US)

(72) Inventors: Plamen A. Ivanov, Schaumburg, IL (US); Adrian M. Schuster, West Olive, MI (US)

(21) Appl. No.: 15/605,522

(22) Filed: May 25, 2017

(51) Int. Cl. G06F 3/16; H04S 7/00; G06F 17/28; G06F 3/01

(52) U.S. Cl. CPC G06F 3/165; H04S 7/30; H04S 2400/11; G06F 3/017; G06F 17/28

(57) ABSTRACT

The present application provides a method and device for processing audio in a captured scene including an image and spatially localizable audio. The method includes capturing a scene including image information and spatially localizable audio information. The captured image information of the scene is then presented to a user via an image reproduction module. An object in the presented image information is then selected, which is the source of spatially localizable audio information, by isolating the spatially localizable audio information in the direction of the selected object. The isolated spatially localizable audio information is then altered.

### FIELD OF THE APPLICATION

The present application relates generally to the processing of audio in a captured scene, and more particularly, where the captured scene includes an image and spatially localizable audio, which is adjusted, where the particular spatially localizable audio that is adjusted is associated with an object from the captured scene that is selected by a user.

### BACKGROUND

As computing power increases relative to personal computers and/or hand held electronic devices, virtual reality and augmented reality applications are beginning to become more mainstream, and are generally beginning to become more available to the average consumer. While virtual reality applications may attempt to create a substitute for the real world with a simulated world, augmented reality attempts to alter one's perception of the real world through an addition, an alteration, or a subtraction of elements from a real world experience.

While most augmented reality experiences focus extensively on addressing the visual aspects of reality, the present inventors recognize that an ability to make adjustments that affect the other senses such as sound, smell, taste and/or touch can further enhance the experience. However in order to effectively address the other senses, it often requires an ability to spatially isolate perceived aspects of the other senses, and associate them with objects and/or spaces that are visually being presented to the user. For example, when visually adding, altering, and/or removing an object from a scene, a failure to similarly add, alter, and/or remove other aspect of the object such as any sound being produced by the object, can result in the intended change to reality having a less than desired immersive effect. While it can be relatively straight forward to alter the visual aspects of a scene and/or elements within a scene, the pairing and corresponding adjustment of the perceived portion of the audio with the affected visual elements or aspects can sometimes be less straight forward, and can be further complicated by an augmented reality application that attempts to modify at the user's direction the user's experience in real time.

The present inventors have recognized that in order to enhance an augmented reality experience, it would be beneficial to be able to identify and address spatially localizable audio aspects of an experience in addition to the visual aspects of an experience, and to match the particular spatially localizable audio aspects and any changes thereto with the visual aspects being perceived and selected for adjustment by the user.

### SUMMARY

The present application provides a method for processing audio in a captured scene including an image and spatially localizable audio. The method includes capturing a scene including image information and spatially localizable audio information. The captured image information of the scene is then presented to a user via an image reproduction module. An object in the presented image information is then selected, which is the source of spatially localizable audio information, by isolating the spatially localizable audio information in the direction of the selected object. The isolated spatially localizable audio information is then altered.

In at least some instances, altering the isolated spatially localizable audio information includes adjusting characteristics of the isolated spatially localizable audio information, where in some instances adjusting the characteristics of the isolated spatially localizable audio information can include altering the apparent location of origin of the isolated spatially localizable audio information.

In at least some further instances, altering the isolated spatially localizable audio information includes removing the isolated spatially localizable audio information prior to modification, and replacing the removed isolated spatially localizable audio information with updated spatially localizable audio information.

In at least some still further instances, the method further includes altering an appearance of the selected object in the presented image information.

The present application further provides a device for processing audio in a captured scene including an image and spatially localizable audio. The device includes an image capture module for receiving image information, a spatially localizable audio capture module for receiving spatially localizable audio information, and a storage module for storing at least some of the received image information and received spatially localizable audio information. The device further includes an image reproduction module for presenting captured image information to a user, and a user interface for receiving a selection from the user, which corresponds to an object in the captured image information presented to the user. The device still further includes a controller, which includes an object direction identification module for determining a direction of the selected object within the captured scene information, a spatially localizable audio information isolation module for isolating the spatially localizable audio information within the captured scene information in the direction of the selected object, and a spatially localizable audio information alteration module for altering the isolated spatially localizable audio information.

These and other objects, features, and advantages of the present application are evident from the following description of one or more preferred embodiments, with reference to the accompanying drawings.

### BRIEF DESCRIPTION OF THE DRAWINGS

FIG. 1 is a front view of an exemplary device for processing audio in a captured scene;

FIG. 2 is a rear view of an exemplary device for processing audio in a captured scene;

FIG. 3 is an example of a scene, which can be captured, within which image information and spatially localizable audio information could be included;

FIG. 4 is a corresponding representation of the exemplary scene illustrated in FIG. 3, that includes examples of potential augmentation, for presentation to the user via an exemplary device;

FIG. 5 is a block diagram of an exemplary device for processing audio in a captured scene, in accordance with at least one embodiment;

FIG. 6 is a more specific block diagram of an exemplary controller for managing the processing of audio in a captured scene;

FIG. 7 is a graphical representation of one example of a potential form of beam forming that can be produced by a microphone array;

FIG. 8 is a flow diagram of a method for processing audio in a captured scene including an image and spatially localizable audio; and

FIG. 9 is a more detailed flow diagram of alternative exemplary forms of altering the isolated spatially localizable audio information.

### DETAILED DESCRIPTION OF THE PREFERRED EMBODIMENT(S)

While the present application is susceptible of embodiment in various forms, there is shown in the drawings and will hereinafter be described presently preferred embodiments with the understanding that the present disclosure is to be considered an exemplification and is not intended to be limited to the specific embodiments illustrated.

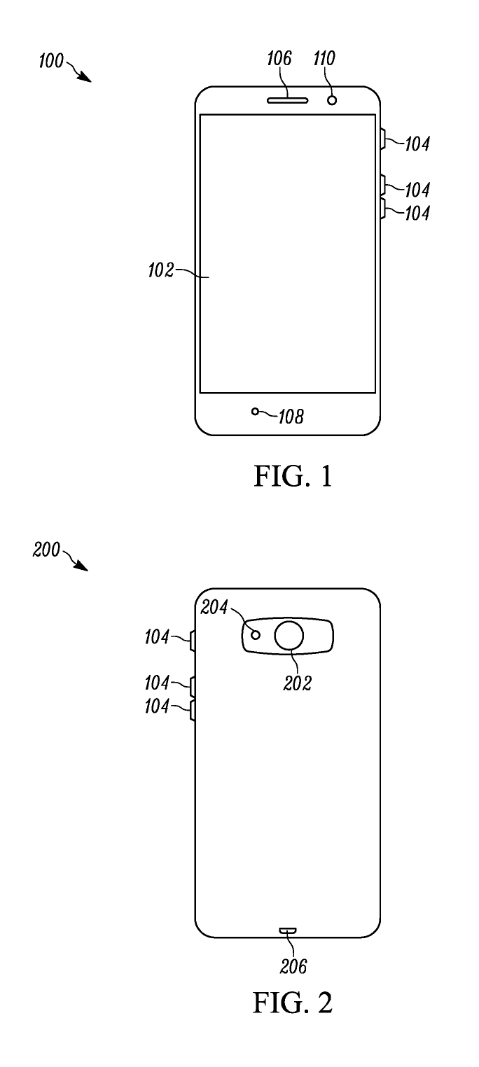

FIG. 1 illustrates a front view of an exemplary device 100 for processing audio in a captured scene, such as an electronic device. While in the illustrated embodiment, the type of device shown is a radio frequency cellular telephone, which is capable of augmented reality type functions including capturing a scene and presenting at least aspects of the captured scene to the user via a display and one or more speakers, other types of devices that are capable of providing augmented reality type functions are also relevant to the present application. In other words, the present application is generally applicable to devices beyond the type being specifically shown. A couple of additional examples of suitable devices that may additionally be relevant to the present application in the management of an augmented reality scene can include a tablet, a laptop computer, a desktop computer, a netbook, a gaming device, a personal digital assistant, as well as any other form of device that can be used to isolate and manage spatially localizable audio associated with one or more identified elements from a captured scene. The exemplary device of the present application could additionally be used with one or more peripherals and/or accessories, which could be coupled to a main device. The peripherals and/or accessories could include modular portions that could attach to a main device, that could be used to supplement the functionality of the device. As an example, the modular portion could be used to provide enhanced image capture, audio capture, image projection, audio playback, and/or supplemental power. The peripherals and/or accessories that may be used with the exemplary device could include virtual reality goggles and headsets. The functionality associated with virtual reality goggles and headsets could also be integrated as part of a main device.

In the illustrated embodiment, the device corresponding to a radio frequency telephone includes a display 102 which covers a large portion of the front facing. In at least some instances, the display 102 can incorporate a touch sensitive matrix, that can help facilitate the detection of one or more user inputs relative to at least some portions of the display, including an interaction with visual elements being presented to the user via the display 102. In some instances, the visual elements could correspond to objects with which the user can interact. In other instances, the visual element can form part of a visual representation of a keyboard including one or more virtual keys and/or one or more buttons with which the user can interact and/or select for a simulated actuation. In addition to one or more virtual user actuatable buttons or keys, the device 100 can include one or more physical user actuatable buttons 104. In the particular embodiment illustrated, the device has three such buttons located along the right side of the device.

The exemplary device 100, illustrated in FIG. 1, additionally includes a speaker 106 and a microphone 108, which can be used in support of voice communications. The speaker 106 may additionally support the reproduction of an audio signal, which could be a stand-alone signal, such as for use in the playing of music, or can be part of a multimedia presentation, such as for use in the playing of a movie and/or reproducing aspects of a captured scene, which might have at least an audio as well as a visual component. The speaker 106 may also include the capability to also produce a vibratory effect. However, in some instances, the purposeful production of vibrational effects may be associated with a separate element, not shown, which is internal to the device. Generally, at least one speaker 106 of the device 100 is located toward the top of the device, which corresponds to an orientation consistent with the respective portion of the device facing in an upward direction during usage in support of a voice communication. In such an instance, the speaker 106 might be intended to align with the ear of the user, and the microphone 108 might be intended to align with the mouth of the user. Also located near the top of the device, in the illustrated embodiment, is a front facing camera 110.

While in the particular embodiment shown, a single speaker 106 and a single microphone 108 are illustrated, the device 100 could include more than one of each, to enable spatially localizable information to be captured and/or encoded in the audio to be played back and perceived by the user. It is further possible that the device could be used with a peripheral and/or an accessory, which can be used to supplement the included image and audio capture and/or playback capabilities.

FIG. 2 illustrates a back view of the exemplary device 100 for processing audio in a captured scene, illustrated in FIG. 1. In the back view of the exemplary device, the three physical user actuatable buttons 104, which are visible in the front view, can similarly be seen. The exemplary device 100 additionally includes a back side facing camera 202 with a flash 204, as well as a serial bus port 206, which can accommodate receiving a cable connection, which can be used to receive data and/or power signals. The serial bus port 206 can also be used to connect a peripheral, such as a peripheral that includes a microphone array including multiple sound capture elements. The peripheral could also include one or more cameras, which are intended to capture respective images from multiple directions. While the serial bus port 206 is shown proximate the bottom of the device, the location of the serial bus port could be along alternative sides of the device to allow a correspondingly attached peripheral to have a different location relative to the device.

In addition and/or alternative to the serial bus port 206, a connector port could take still further forms. For example, an interface could be present on the back surface of the device which includes pins or pads arranged in a predetermined pattern for interfacing with another device, which could be used to supply data and/or power signals. It is also possible that additional devices could interface or interact with a main device through a less physical connection, that may incorporate one or more forms of wireless communications, such as radio frequency, infra-red (IR), near field (NFC), etc.

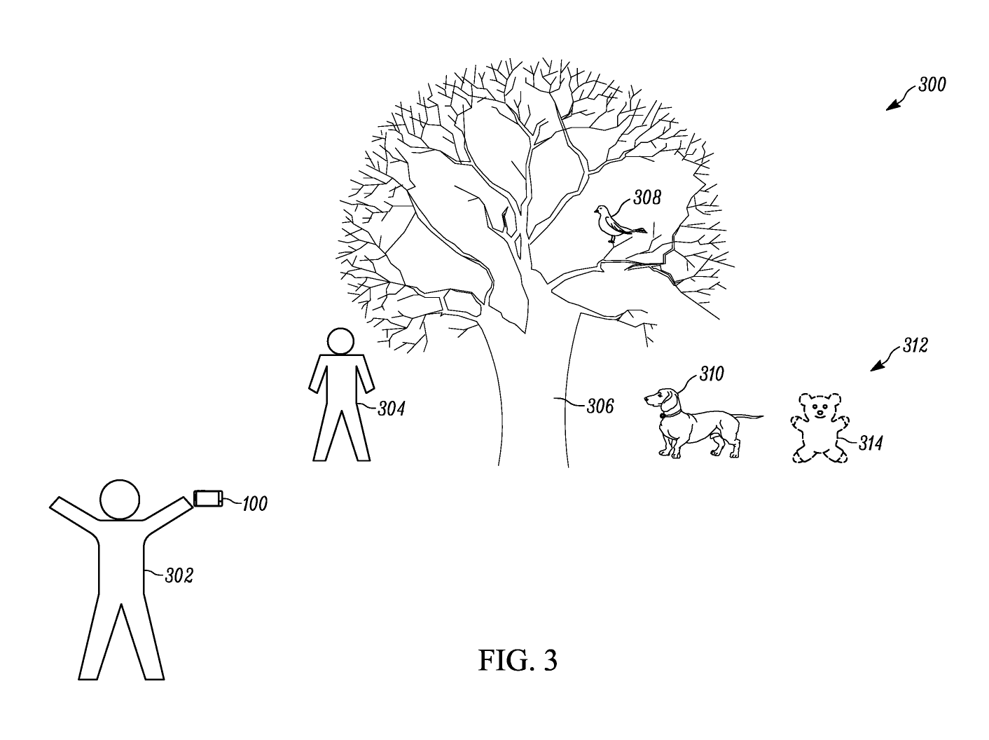

FIG. 3 illustrates an example of a scene 300, which can be captured, within which image information and spatially localizable audio information could be included. In the illustrated exemplary scene, a user 302 holding an exemplary device 100 is capturing image information and spatially localizable audio information. The scene includes another person 304, a tree 306 with a bird 308 in it, and a dog 310. Also shown, is a spot 312 where a potential virtual character 314 might be added.

In an augmented reality scene, a virtual character may be added, and an existing entity may be changed and/or removed. The changes could include alterations to the visual aspects of elements captured in the scene, as well as other aspects associated with other senses including audio aspects. For example, the sounds that the bird or the dog may be making could be altered. In some instances, the dog could be made to sound more like a bird, and the bird could be made to sound more like a dog. In other instances, the augmented reality scene could be altered to convert the sounds the dog and the bird are making to appear to be more like the language of a person. Alternatively and/or additionally, the tone and/or the intensity of the animal sounds could be altered to create or enhance the emotions appearing to be conveyed. For example, the sound coming from a particular animal could be amplified with respect to the surroundings and other characters, so that the user/observer is able to focus more on the behavior of the particular animal. Still further, a change in the environmental surroundings, real or virtual, could be accompanied by changes to the animal sounds, by adding equalization and/or reverb.

A virtual conversation involving the user 302 with another entity included in the scene and/or added to the scene could be created as part of an augmented reality application which is being executed on the device 100. In some instances, a virtual conversation between the user and a virtual character could be used to support the addition of services, such as the services of a virtual guide or narrator. The added and/or altered aspects of the scene could be included in the information being presented to the user 302 via the device 100 which is also capturing the original scene, such as via the display 102 of the device 100.

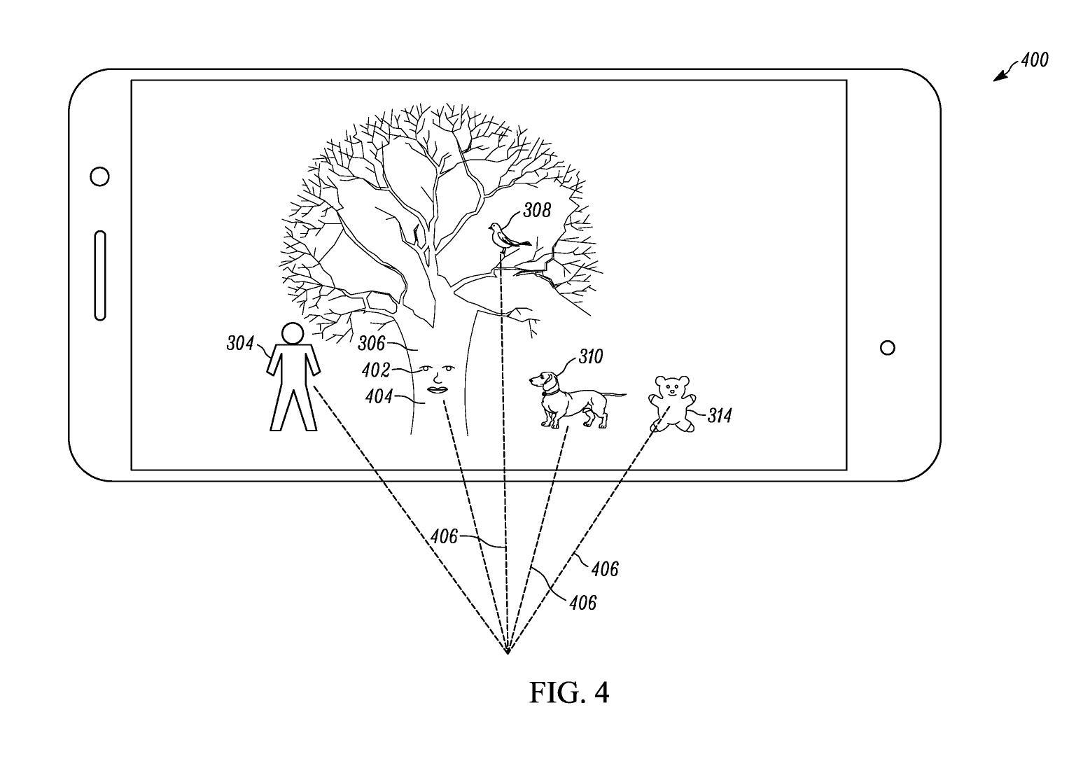

FIG. 4 illustrates a corresponding representation 400 of the exemplary scene 300 illustrated in FIG. 3, that includes examples of potential augmentation, for presentation to the user 302 via an exemplary device 100. For example, the augmented exemplary scene includes the addition of the virtual character 314, that was hinted at in FIG. 3. The scene additionally includes an addition of a more human like face 402 to a trunk 404 of the tree 306, which could support further augmentations, where a more human like voice and expressions could also be associated with the tree 306. Other forms of augmentation, are also possible. Such as, the tree could be replaced with an image of a falling tree, and corresponding sounds associated with the falling tree could also be added to the scene. Dashed lines 406 highlight a determined direction for each of the corresponding elements, which was identified in the application, and help to highlight a spatial relationship relative to the user 302 of each of the several separately identified elements from the scene 300, which can be used by the augmented reality application being executed in the device 100 in the processing of augmented features.

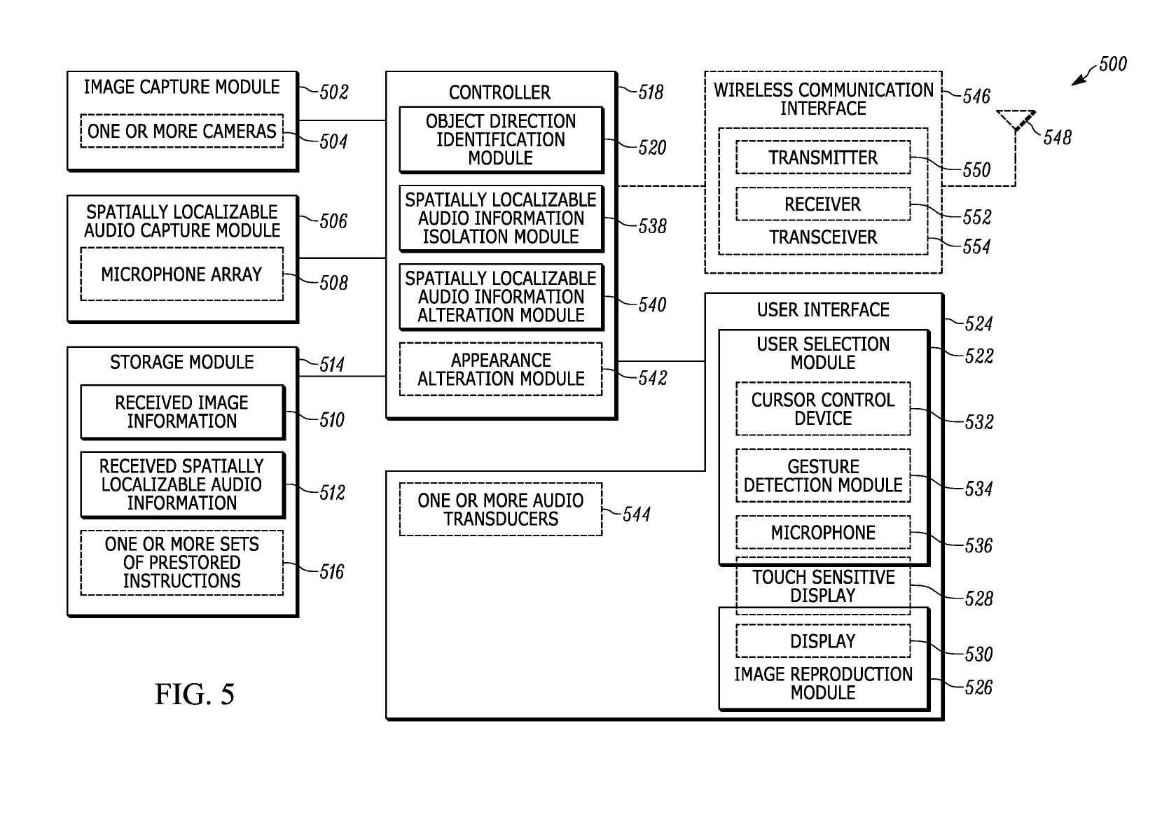

FIG. 5 illustrates a block diagram 500 of an exemplary device for processing audio in a captured scene, in accordance with at least one embodiment. The exemplary device includes an image capture module 502, which in at least some instances can include one or more cameras 504. The image capture module 502 can capture a visual image associated with a scene, which in turn could be stored, recorded and/or presented to the user, either in its original and/or augmented form. Furthermore, the presentation of the captured image could be used by the user 302 to identify where and how any of the aspects or elements contained within the captured image for subsequent augmentation should be added, removed, changed and/or adjusted.

The exemplary device further includes a spatially localizable audio capture module 506, which in at least some instances can include a microphone array 508 including a plurality of spatially distinct audio capture elements. The ability to spatially localize captured audio enables the captured audio to be isolated and/or associated with various areas in a captured image, which can then be correspondingly associated with items, elements and characters contained within an image. In at least some instances, the identified spatially distinct audio corresponds to various streams of audio that are each received from a particular direction, where the nature and arrangement of the audio capture elements within a microphone array can be used to help determine the spatial ability to differentiate between the various sources of received audio. In at least some instances, the microphone array 508 can be included as part of a peripheral that can attach to the device 100 via one or more ports, which can include a universal serial bus port, such as port 206.

Once captured, the received image information 510 and received spatially localizable audio information 512 can be maintained in a storage module 514. Once maintained in the storage module 514, the captured image information 510, and audio information 512 can be modified and/or adjusted so as to alter and/or augment the information, that is subsequently presented to the user and/or one or more other people as part of the augmented scene. The storage element 514 could include one or more forms of volatile and/or non-volatile memory, including conventional ROM, EPROM, RAM, or EEPROM. The possible additional data storage capabilities may also include one or more forms of auxiliary storage, which is either fixed or removable, such as a hard drive, a floppy drive, or a memory stick. One skilled in the art will further appreciate that other still further forms of storage elements could be used in connection with the processing of audio in a captured scene without departing from the teachings of the present disclosure. The storage module can additionally include one or more sets of prestored instructions 516, which could be used in connection with a microprocessor that could form all or parts of a controller in the management of the desired functioning of the device 100 and/or one or more applications being executed on the device.

Correspondingly, adjustments of the captured information is generally managed under the control of a controller 518, which can be associated with one or more microprocessors. In some of the same or other instances, the controller can incorporate state machines and/or logic circuitry, which can be used to implement at least partially, various modules and/or functionality associated with the controller 518. In some instances, all or parts of storage module 514 could also be incorporated as part of the controller 518.

In the illustrated embodiment, the controller 518 includes an object direction identification module 520, which can be used to determine a selected object and a corresponding direction of the selected object within the scene relative to the user 302 and the device 100. The selection is generally managed using a user selection module 522 of the user interface 524, which can be included as part of the device 100. In some instances, the user selection module 522 is incorporated as part of a touch sensitive display 528, which is also capable of visually presenting captured scene information to the user 302 as part of an image reproduction module 526 of the user interface 524. The use of a display 530 for use in visually presenting captured scene information to the user, which does not incorporate touch sensitive capability, is also possible. However, in such instances, an alternative form of accepting input from the user for purposes of user selection may be used.

Alternative to and/or in addition to using a touch sensitive display 528 for purposes of receiving a user selection from the user 302, the user selection module can additionally or alternatively include one or more of a cursor control device 532, a gesture detection module 534, or a microphone 536. The cursor control device 532 can include the use of one or more of a joystick, a mouse, a track pad, a track ball or a track point, each of which could be used to move a cursor relative to an image being presented via a display. When a selection is indicated, the position of the cursor may highlight and/or coincide with an associated area or element in the image being displayed, which allows the corresponding area or element to be selected.

A gesture detection module 534 could be used to detect movements of the user 302 and/or a pointer controlled by the user relative to the device 100, which in turn could have one or more predesignated meanings, which might allow the controller 518 to identify elements or areas in the image information and better manage any adjustments to the captured scene. In some instances, the gesture detection module 534 could be used in conjunction with a touch sensitive display 528 and/or a related set of sensors. For example, the gesture detection module could be used to detect a scratching relative to an area or element being visually presented to the user. The scratching might be used to indicate a user's desire to delete an object associated with the corresponding area or element being scratched. Alternatively, the gesture detection module could be used to detect an object selection gesture, such as a circling gesture, which could be used to identify a selection of an object.

A microphone 536 could still further alternatively and/or additionally be used to provide a detectable audible description from the user, which might assist in the selection of an area or element to be affected by a desired subsequent augmentation. Language parsing could be used to determine the meaning of the detected audible description, and the determined meaning of the audible description might then be paired with a corresponding visual context that might have been determined to be contained in the captured image information being presented to the user.

Once a direction for the object and/or area to be affected has been determined, the controller 518, including a spatially localizable audio information isolation module 538, can then identify audio associated with the identified object and/or area with the assistance of the spatially localizable audio capture module 506. The identified spatially localized audio associated with the area or object of interest can then be altered using a spatially localizable audio information alteration module 540, which is included as part of the controller 518. In some instances, in addition to altering the identified spatially localized audio associated with a particular area or object, it may be desirable to also alter the corresponding visual appearance of the same. Such an alteration could be managed using a corresponding appearance alteration module 542. The captured scene, which has been augmented and/or altered could then be presented to the user 302 and/or others. For example, the augmented/altered version of the captured scene could be presented to the user 302 using the display 102 and one or more audio transducers 544, which can sometimes take the form of one or more speakers. In some instances, the one or more audio transducers 544 will include speaker 106, which is illustrated in FIG. 1.

In at least some instances, the device 100 will also include wireless communication capabilities. Where the device 100 includes wireless communication capabilities, the device will generally include a wireless communication interface 546, which is coupled to an antenna 548. The wireless communication interface 546 can further include one or more of a transmitter 550 and a receiver 552, which can sometimes take the form of a transceiver 554. While at least some of the illustrated embodiments of the present application can incorporate wireless communication capabilities, such capabilities are not essential.

By incorporating wireless communication capabilities, one may be able to distribute at least some of the processing associated with any alteration of the audio in a captured scene, including the offloading of all or parts of the processing to another device, such as a central server that could be part of the wireless communication network infrastructure. Furthermore, the microphone array could incorporate microphones from other nearby devices, which may be communicatively coupled to the device 100 via the wireless communication interface 546. It may still further be possible to offload and/or distribute other aspects of the present application making use of wireless communication capabilities without departing from the teachings of the present application.

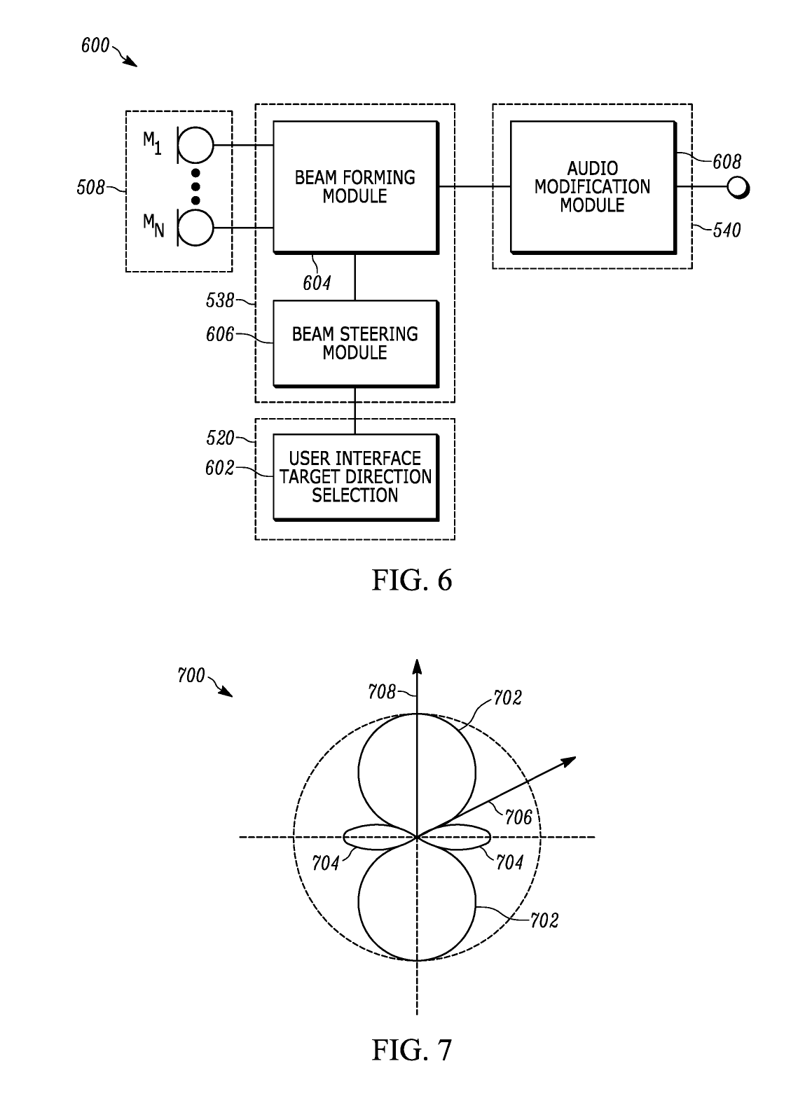

FIG. 6 illustrates a more specific block diagram 600 of an exemplary controller for managing the processing of audio in a captured scene. In the more specific block diagram 600, the exemplary controller includes a user interface target direction selection module 602, which is used to identify an object or area in the image information from a captured scene, and determine a corresponding direction of the identified object or area relative to the device 100. Based upon the determined direction, a corresponding set of parameters can be determined for combining the inputs of the microphones M₁ through M_{N}, so as to highlight the desired portion of the detected spatially localizable audio information from the scene.

By controlling the weighting and the relative delays of the various microphone inputs before combining, one can form a beam pattern that can then be used to enhance and/or diminish the audio received from different directions, the corresponding beam pattern can then be directed appropriately toward different areas of the captured scene, so as to help isolate a particular portion of the audio. The process of combining and beam forming can be performed in either the time or the frequency domains. It is further possible that other alternatives are possible. For example, it may be possible to extract the voice of the talker and/or audio to be isolated out of a scene by using a conventional noise-suppression techniques, that need not rely on beam-forming. Alternatively, blind source separation, independent component analysis, and other techniques for computational auditory scene analysis can separate the components of the audio stream, and allow them to be associated with the objects in the view-finder.

FIG. 7 illustrates a graphical representation 700 of one example of a potential form of beam forming that can be produced by a microphone array 508. For example, in the illustrated embodiment, the beam pattern illustrated in FIG. 7, includes a pair of primary lobes 702, and a pair of secondary side lobes 704. Between each of the respective primary lobes 702 and the secondary lobes 704 are nulls where the audio detected from those directions 706 may be minimized. The exact nature of the beam pattern that is formed can often be controlled by adjusting the location of microphones within an array and controlling the relative weighting, filtering and delays applied to each of the audio input sources prior to combining. Some input sources can be split into multiple audio streams that are then separately weighted and delayed prior to being combined. In this way a spatially localizable audio capture module 506 with a maximum sensitivity oriented in a desired direction 708 can be created. In the illustrated embodiment, the exemplary controller includes a beam forming module 604 for creating a desired beam forming shape including one or more lobes as well as possibly one or more nulls, and a separate beam steering module 606 for directing the various lobes and nulls toward a particular direction. The steering of a null in a particular direction could have the effect of removing the audio from that direction.

By steering a beam in the determined direction of a particular element and/or area, the audio from that element and/or area can be highlighted and correspondingly isolated. Once isolated, the audio associated with the elements or areas in the corresponding direction can be morphed and/or altered as desired by an audio modification module 608. For example, level adjustments can be made to all or parts of the isolated audio, as well as audio effects could be added, which affect various characteristics of the isolated audio. Examples of audio characteristics that can be adjusted can include adding reverberations, spectral enhancements, pitch shifting and/or time scale changes. It is further possible to remove the isolated audio and replace the same with different audio information. The replacement audio could include synthesized, or other recorded sounds. In some instances, the recorded sounds being used for addition and/or replacement may come from a data base. For example, audio from a database having verbal content could be added in such a way that it is associated with an object, such as a tree 306 or a dog 310, or a virtual character.

In some instances, the replacement audio could be based upon determined characteristics of the audio that was being removed. For example, the verbal content of the isolated audio associated with a person 304 in a captured scene could be identified, converted into another language, and then reinserted into the scene. In another instance, the isolated audio information associated with one of the elements from the captured scene, such as a bird 308, could be altered to more closely correspond to audio information associated with another element from the capture scene, such as a dog 310, or vice versa. In such an instance, some of the characteristics of the original audio, such as audio pitch could be preserved.

In still other instances, the adjustments to the audio information could track and/or correspond to adjustments being made to the visual information within a captured scene. For example, a person 304 in a scene could be made to look more like a ghost, where corresponding changes to the audio information could include the addition of an amount of reverb to the same to sound more ghost-like. It is further possible to alter the isolated audio, so as to make it sound like it came from another point within the captured scene, where the location of the visual representation of the apparent source within the captured scene could also be adjusted. In such an instance, the audio could include adjusted volume level and time delay to account for the change in location, as well as adjusted reverb.

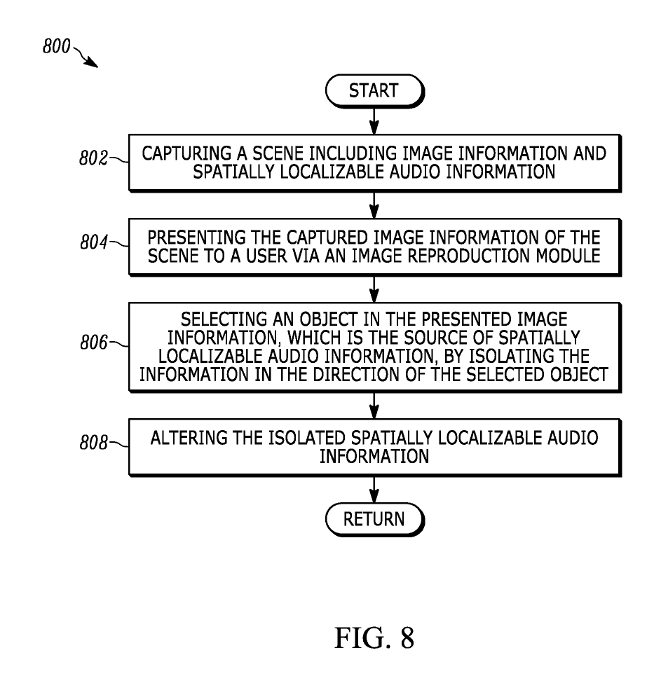

FIG. 8 illustrates a flow diagram 800 of a method for processing audio in a captured scene including an image and spatially localizable audio. The method includes capturing 802 a scene including image information and spatially localizable audio information. The captured image information of the scene is then presented 804 to a user via an image reproduction module. An object in the presented image information, which is the source of spatially localizable audio information is then selected 806 by isolating the audio information received in the direction of the selected object. The isolated spatially localizable audio information is then altered 808.

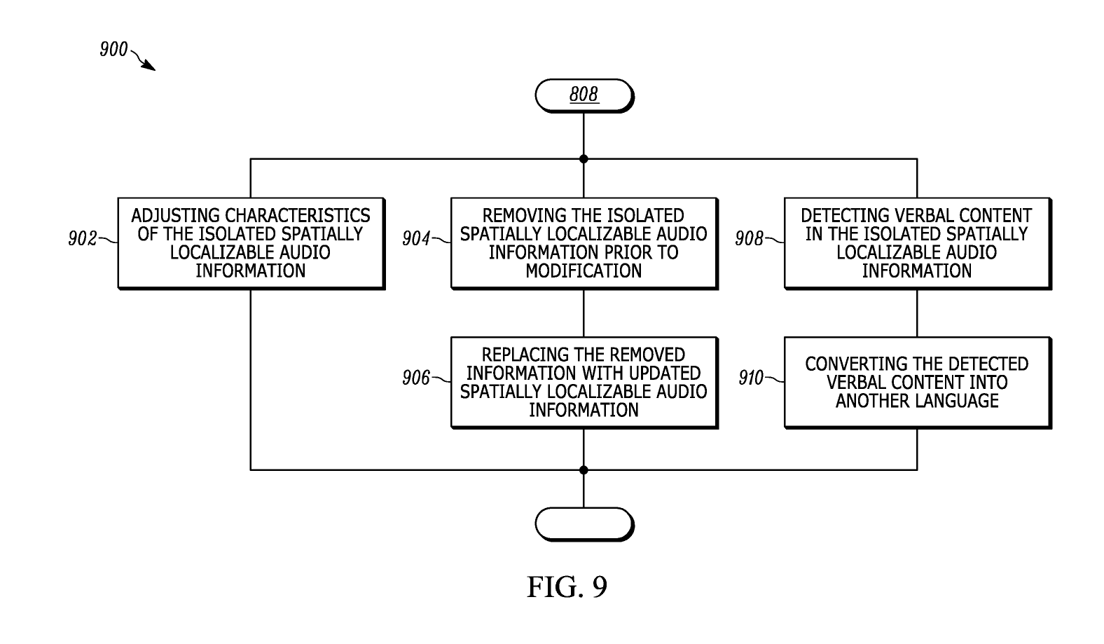

FIG. 9 illustrates a more detailed flow diagram 900 of alternative exemplary forms of altering 808 the isolated spatially localizable audio information. The alternative exemplary forms can include adjusting 902 the characteristics of the isolated spatially localizable audio information. The alternative exemplary forms can further include removing 904 the isolated spatially localizable audio information prior to modification, and replacing 906 the removed information with updated spatially localizable audio information. The alternative exemplary forms can still further include detecting 908 verbal content in the isolated spatially localizable audio information, and converting 910 the detected verbal content into another language.

While the preferred embodiments have been illustrated and described, it is to be understood that the application is not so limited. Numerous modifications, changes, variations, substitutions and equivalents will occur to those skilled in the art without departing from the spirit and scope of the present application as defined by the appended claims.

What is claimed is:

1. A method for processing audio in a captured scene including an image and spatially localizable audio, the method comprising:
capturing a scene including image information and spatially localizable audio information;
presenting the captured image information of the scene to a user via an image reproduction module;
selecting an object in the presented image information, which is the source of spatially localizable audio information, by isolating the spatially localizable audio information in the direction of the selected object; and
altering the isolated spatially localizable audio information.

2. A method in accordance with claim 1, wherein altering the isolated spatially localizable audio information includes adjusting characteristics of the isolated spatially localizable audio information.

3. A method in accordance with claim 2, wherein adjusting the characteristics of the isolated spatially localizable audio information includes making level adjustments of all or parts of the isolated spatially localizable audio information.

4. A method in accordance with claim 2, wherein adjusting the characteristics of the isolated spatially localizable audio information includes adding audio effects to all or parts of the isolated spatially localizable audio information.

5. A method in accordance with claim 4, wherein the added audio effects include adding reverberations to all or parts of the isolated spatially localizable audio information.

6. A method in accordance with claim 4, wherein the added audio effects include adding pitch shifting to all or parts of the isolated spatially localizable audio information.

7. A method in accordance with claim 4, wherein the added audio effects include adding time scale changes to all or parts of the isolated spatially localizable audio information.

8. A method in accordance with claim 2, wherein adjusting the characteristics of the isolated spatially localizable audio information includes altering the apparent location of origin of the isolated spatially localizable audio information.

9. A method in accordance with claim 1, wherein altering the isolated spatially localizable audio information includes
removing the isolated spatially localizable audio information prior to modification, and
replacing the removed isolated spatially localizable audio information with updated spatially localizable audio information.

10. A method in accordance with claim 9, wherein the updated spatially localizable audio information is a modified version of the isolated spatially localizable audio information.

11. A method in accordance with claim 1, wherein altering the isolated spatially localizable audio information includes
detecting verbal content in the isolated spatially localizable audio information, and
converting the detected verbal content into another language.

12. A method in accordance with claim 1, further comprising altering an appearance of the selected object in the presented image information.

13. A device for processing audio in a captured scene including an image and spatially localizable audio, the device comprising:
an image capture module for receiving image information;
a spatially localizable audio capture module for receiving spatially localizable audio information;
a storage module for storing at least some of the received image information and received spatially localizable audio information;
an image reproduction module for presenting captured image information to a user;
a user interface for receiving a selection from the user, which corresponds to an object in the captured image information presented to the user; and
a controller including
an object direction identification module for determining a direction of the selected object within the captured scene information,
a spatially localizable audio information isolation module for isolating the spatially localizable audio information within the captured scene information in the direction of the selected object, and
a spatially localizable audio information alteration module for altering the isolated spatially localizable audio information.

14. A device in accordance with claim 13, wherein the image reproduction module and user interface are included as part of a touch sensitive display, which presents captured image information to the user and receives the selection from the user, which corresponds to the object in the captured image information presented to the user.

15. A device in accordance with claim 13, wherein the user interface includes a cursor control device for use in moving a cursor on the image reproduction module and selecting an object within the captured scene information.

16. A device in accordance with claim 13, wherein the user interface includes a gesture detection module, which tracks a movement of one or more of a portion of the user or a pointer controlled by the user relative to the device, or a movement of the device relative to the user.

17. A device in accordance with claim 13, wherein the user interface includes a microphone for receiving a verbal description of an object within the captured scene information, and a visual context determination and association module for identifying contextual information within the captured scene information, and associating it with the received verbal description.

18. A device in accordance with claim 13, wherein the controller further includes an appearance alteration module for altering the appearance of the selected object in the presented image information.

19. A device in accordance with claim 13, further comprising an audio reproduction module for presenting the altered isolated spatially localizable audio information to the user.

20. A device in accordance with claim 13, where the device includes a mobile wireless communication device.
